(19) United States
(12) Patent Application Publication
(10) Pub. No.: US 2014/0297212 A1
(43) Pub. Date: Oct. 2, 2014

(54) Systems and Methods for Compensating for a Misalignment Angle Between an Accelerometer and a Magnetometer

(71) Applicant: KIONIX, INC., Ithaca, NY (US)

(72) Inventor: Erik ANDERSON, Sunnyvale, CA (US)

(73) Assignee: Kionix, Inc., Ithaca, NY (US)

(21) Appl. No.: 13/855,341

(22) Filed: Apr. 2, 2013

(51) Int. Cl. G01C 25/00

(52) U.S. Cl. CPC G01C 25/005
USPC 702/90

(57) ABSTRACT

A method for compensating for a misalignment angle between an accelerometer and a magnetometer includes applying a corrective rotation to collected accelerometer data or magnetometer data based on an estimated misalignment angle between an axis of the accelerometer and an axis of the magnetometer. The method further includes estimating a gravity vector using the corrected accelerometer data and estimating a magnetic field vector using the corrected magnetometer data. Additionally, the method includes calculating a characteristic that is a function of a calculated angle between the estimated gravity vector and the estimated magnetic field. The method also includes calculating a figure of merit over the plurality of times that is a function of the characteristic, and dynamically adjusting the estimated misalignment angle during ordinary use of the electronic device such that the figure of merit converges to a value as the electronic device rotates.

### BACKGROUND

1. Field

Embodiments are directed generally to electronic systems, accelerometers, magnetometers, and specifically, to systems and methods for compensating for a misalignment angle between an accelerometer and a magnetometer in a heading determination.

2. Background Art

Electronic systems can use an accelerometer and a magnetometer for navigation applications, for example, electronic compass applications or any application that determines a heading. An accelerometer is a device that measures the static and dynamic forces on an object. The static force is generated by the Earth's gravitational pull, and dynamic forces are caused by movement or vibrations of the object. Accelerometers can be used to determine the direction of gravity. A magnetometer is a device that measures magnitudes and directions of magnetic fields. Magnetometers can be used to determine the direction of the Earth's magnetic field, which can be used for a heading determination.

Errors in the relative orientation between the accelerometer sensor and the magnetometer sensor (misalignment errors) can cause significant errors in a resulting heading estimate. For example, a misalignment error in the yaw direction (a rotational error about the world z-axis) translates to an equivalent error in the world coordinate heading estimate. A misalignment error in the pitch or roll direction (a rotation error about the world x-axis or world y-axis) can produce an error which varies from being negligible (for example, when the misalignment error projection onto the x-y world plane aligns with the magnetic field, which is also projected onto the x-y world plane) to a value greater than a tilt error itself (for example, when the misalignment error projection onto the x-y world plane is perpendicular to the magnetic field vector, which is also projected onto the x-y world plane).

### BRIEF SUMMARY

In an embodiment, a method for compensating for a misalignment angle between an accelerometer and a magnetometer includes receiving accelerometer data from an accelerometer at a plurality of times and receiving magnetometer data from a magnetometer at the plurality of times. The method also includes applying a corrective rotation to at least one of the accelerometer data and the magnetometer data based on an estimated misalignment angle at the plurality of times. The estimated misalignment angle is an estimate of an actual misalignment angle between an axis of the accelerometer and an axis of the magnetometer. The method further includes estimating a gravity vector using the accelerometer data at the plurality of times and estimating a magnetic field vector using the magnetometer data at the plurality of times. Additionally, the method includes calculating a characteristic that is a function of a calculated angle between the estimated gravity vector and the estimated magnetic field at each of the plurality of times. The method also includes calculating a figure of merit over the plurality of times that is a function of the characteristic, and dynamically adjusting the estimated misalignment angle during ordinary use of the electronic device such that the figure of merit converges to a value as the electronic device rotates about an axis having a component orthogonal to a direction of gravity. Convergence of the figure of merit to the value indicates the estimated misalignment angle is substantially equal to the actual misalignment angle.

In an embodiment, a system includes an accelerometer, a magnetometer, a processor, and a memory storing an estimated misalignment angle between an axis of the accelerometer and an axis of the magnetometer and instructions to be executed by the processor. The instructions include applying a corrective rotation to at least one of accelerometer data and magnetometer data based on an estimated misalignment angle at the plurality of times. The estimated misalignment angle is an estimate of an actual misalignment angle between an axis of the accelerometer and an axis of the magnetometer. The accelerometer data and the magnetometer data are received from an accelerometer and a magnetometer, respectively. The instructions further include estimating a gravity vector using the accelerometer data at the plurality of times and estimating a magnetic field vector using the magnetometer data at the plurality of times. Additionally, the instructions include calculating a characteristic that is a function of a calculated angle between the estimated gravity vector and the estimated magnetic field at each of the plurality of times. The instructions also include calculating a figure of merit over the plurality of times that is a function of the characteristic, and dynamically adjusting the estimated misalignment angle during ordinary use of the electronic device such that the figure of merit converges to a value as an electronic device rotates about an axis having a component orthogonal to the direction of gravity. Convergence of the figure of merit to the value indicates the estimated misalignment angle is substantially equal to the actual misalignment angle.

Further features and advantages of the embodiments, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

The accompanying drawings, which are incorporated herein and form part of the specification, illustrate the embodiments and, together with the description, further serve to explain the principles of the embodiments and to enable a person skilled in the relevant art(s) to make and use the embodiments.

FIG. 1 is a block diagram of a method for compensating for a misalignment angle between an accelerometer and a magnetometer in a heading determination, according to an embodiment.

FIG. 2 is a block diagram of an electronic device according to an embodiment.

FIG. 3 is a block diagram of a method for collecting accelerometer and magnetometer data according to an embodiment.

FIGS. 4A and 4B are schematic diagrams of an electronic device showing a misalignment angle between an accelerometer and a magnetometer according to an embodiment.

FIG. 5 is a block diagram of an electronic device according to an embodiment.

FIG. 6 is a block diagram of an exemplary computing environment in which embodiments of an electronic device may be implemented.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Electronic systems can use an accelerometer and a magnetometer for navigation applications, for example, electronic compass applications or any other navigation application that uses a heading determination. Errors in the relative orientation between the accelerometer sensor and the magnetometer sensor (misalignment errors) can cause significant errors in a resulting heading estimate. For example, a misalignment error in the yaw direction (a rotational error about the world z-axis) translates to an equivalent error in the world coordinate heading estimate. A misalignment error in the pitch or roll direction (a rotation error about the world x-axis or world y-axis) can produce an error which varies from being negligible (for example, when the misalignment error projection onto the x-y world plane aligns with the magnetic field, which is also projected onto the x-y world plane) to a value greater than a tilt error, itself (for example, when the misalignment error projection onto the x-y world plane is perpendicular to the magnetic field vector, which is also projected onto the x-y world plane).

In some embodiments, the misalignment error between the accelerometer sensor and the magnetometer sensor can be determined by observing pluralities of measurement pairs including accelerometer data samples and magnetometer data samples taken at or near the same time. In some embodiments, once the misalignment error is determined, a heading estimate can be corrected by applying a corrective rotation to at least one of the accelerometer data and the magnetometer data such that after the corrective rotation is applied the coordinate axes of the accelerometer sensor are aligned with the magnetometer sensor. In some embodiments, the accelerometer axes are used as the device body coordinate reference, and the corrective rotation is applied to the magnetometer data. In some embodiments, the magnetometer axes are used as the device body coordinate reference, and the corrective rotation is applied to the accelerometer data. In some embodiments, coordinate axes not aligned with either the magnetometer or accelerometer axes are used as the device body coordinate reference, and respective corrective rotation components are applied to both the accelerometer data and the magnetometer data.

A misalignment angle between a measurement axis of the magnetometer and a measurement axis of the accelerometer can be a geometric misalignment angle. For example, misalignment errors that occur when the magnetometer and the accelerometer dies are placed within a single package or are separately packaged and placed on the printed circuit board (PCB) of the electronic device. A misalignment angle between a measurement axis of the magnetometer and a measurement axis of the accelerometer can also be an environmental misalignment angle. For example, soft iron distortions can twist the magnetic field, causing a perceived misalignment angle.

Embodiments of the present invention include methods for compensating for an angle misalignment between a measurement axis of an accelerometer and a measurement axis of a magnetometer of an electronic device in a heading determination. In some embodiments, the compensation method investigates a characteristic of the electronic device that is asymmetric as the electronic device (as well as the accelerometer and magnetometer) moves with a non-zero rotation component that is orthogonal to the direction of gravity (that is, the world z-axis) when the electronic device does not compensate for the misalignment angle between the measurement axis of the accelerometer and the measurement axis of the magnetometer. In some embodiments, the characteristic of the electronic device is a function of an angle between an estimated gravity vector determined by using the accelerometer and an estimated magnetic field vector. The degree of asymmetry of the characteristic, which is indicative of whether an estimated misalignment angle used to compensate accelerometer and magnetometer data is substantially equal to the actual misalignment angle, can be quantified by a figure of merit. For example, the figure of merit can be a second moment about a mean value of the characteristic as well as other suitable expressions as described below. An estimated misalignment angle of a compensation algorithm can be adjusted such that the figure of merit is minimized, and at that point, the heading determination is substantially compensated for the misalignment angle. Thus, adjusting the estimated misalignment angle of a compensation algorithm accordingly compensates for the misalignment angle in accelerometer and magnetometer data. The compensated accelerometer and magnetometer data can be used in a heading determination used, for example, in a navigation application.

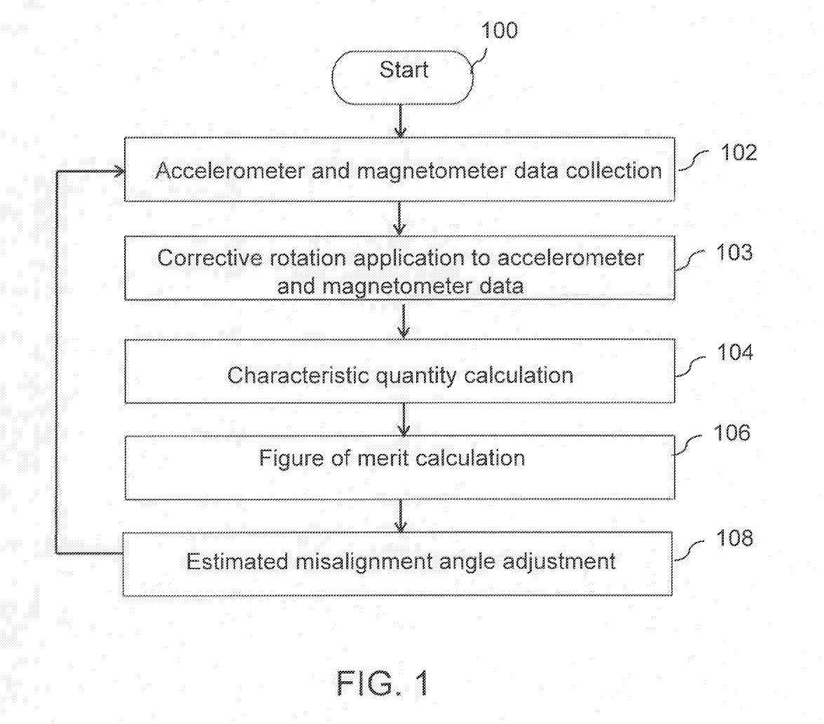

In some embodiments, as shown in FIG. 1, a method 100 for compensating for a misalignment angle between an accelerometer and a magnetometer of an electronic device. Method 100 includes collecting accelerometer and magnetometer data (step 102), application of a corrective rotation to accelerometer and magnetometer data (step 103), calculating a characteristic (step 104), calculating a figure of merit (step 106), and adjusting an estimated misalignment angle between a measurement axis of an accelerometer and a measurement axis of a magnetometer of an electronic device (step 108).

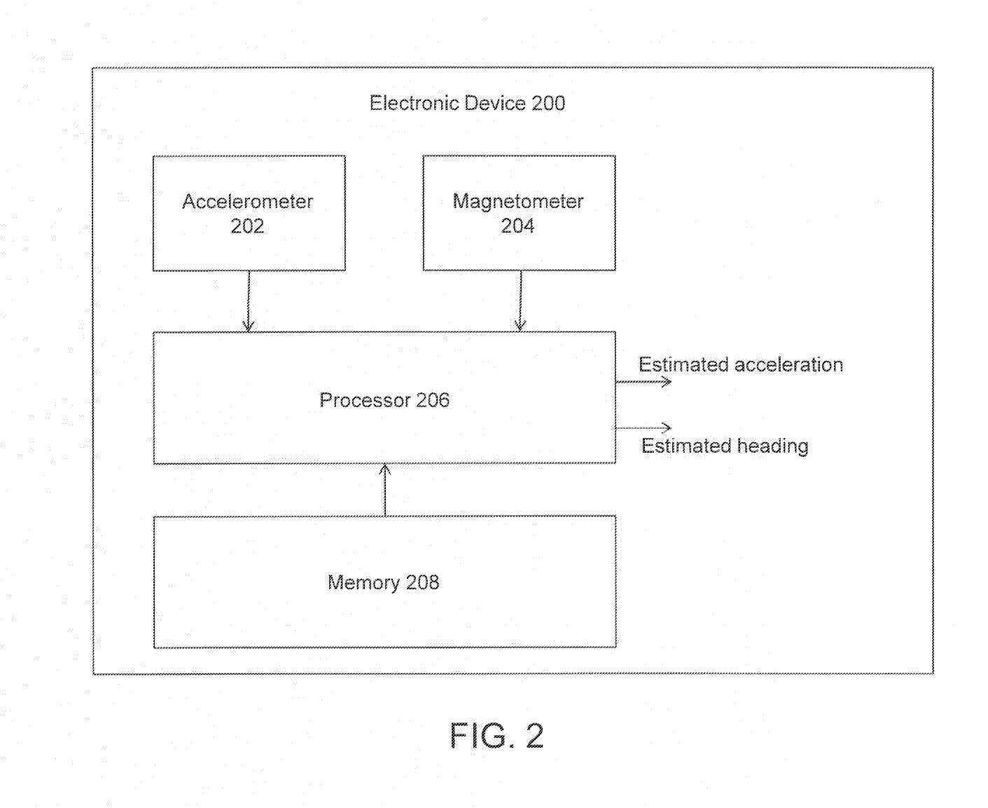

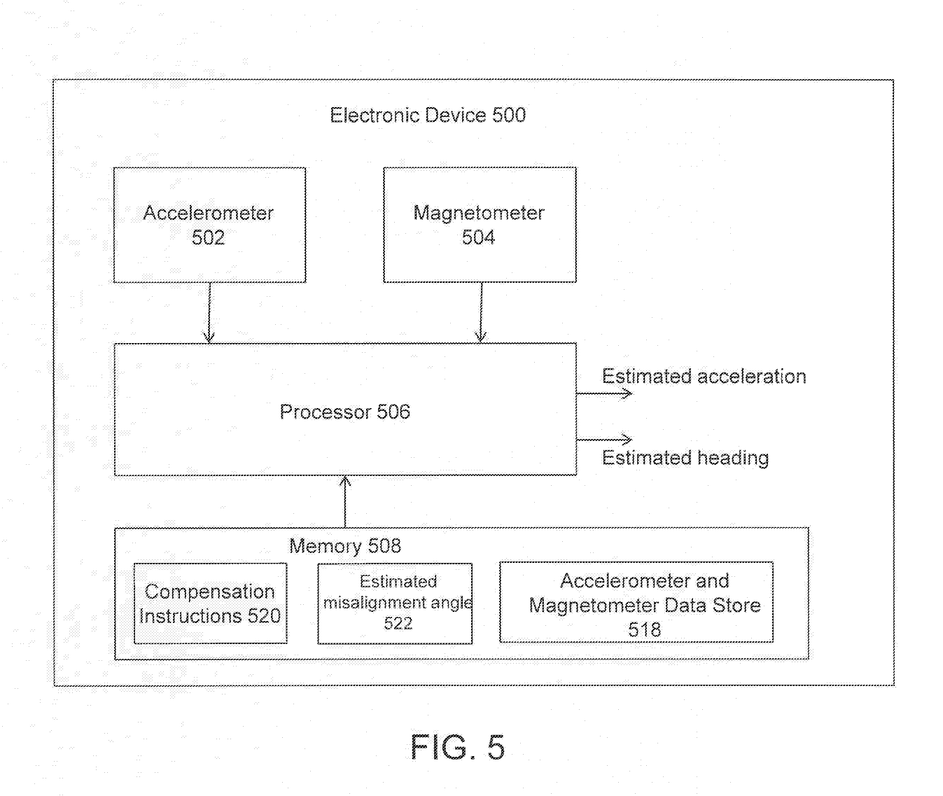

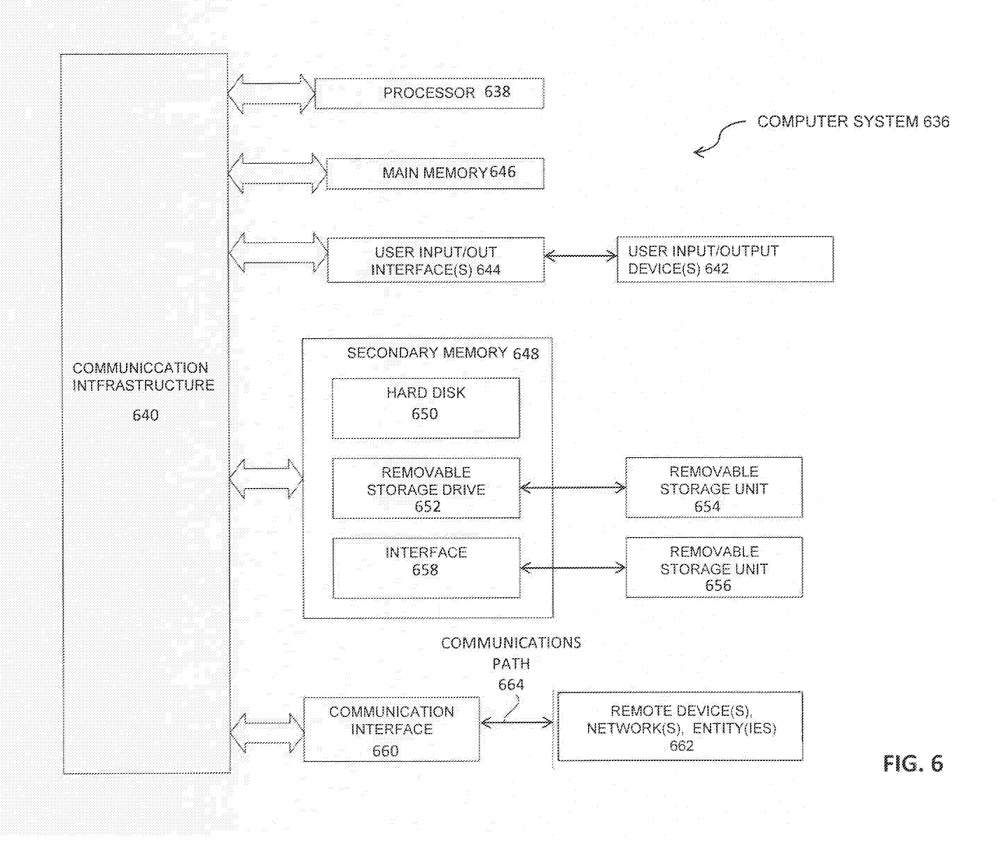

Method 100 can be performed with any suitable electronic device or system having an accelerometer and a magnetometer. For example, FIG. 2 is a block diagram of an electronic device 200 according to an embodiment. Electronic device 200 may be a programmable electronic machine that performs high-speed mathematical and logical operations, and that assembles, stores, correlates and otherwise processes data. In some embodiments, electronic device 200 may be a personal computer, a mobile communication device (for example, a smartphone, a tablet computing device, and a laptop notebook), a set-top box, a game-console, an embedded system, or any other suitable electronic device. In some embodiments, electronic device 200 can be configured to measure the static and/or dynamic forces of acceleration acting thereon and to detect magnetic fields. The features and hardware included in an electronic device according to other embodiments are described with reference to FIGS. 5 and 6.

In some embodiments, electronic device 200 may execute or interpret multiple applications. The applications may be installed or downloaded to electronic device 200, using a network or the external secondary storage units such as those described in FIG. 6. In some embodiments, the applications may be external to electronic device 200, and receive data from electronic device 200 over a network. A network may be any network or combination of networks that can carry data communication. Such a network may include, but is not limited to, a local area network, metropolitan area network, and/or wide area network, such as the Internet. A network can support protocols and technologies including, but not limited to, World Wide Web protocols and/or services. The applications are executed on or receive data from electronic device 200. In some embodiments, one or more of the applications can be a navigational application that determines an estimated heading.

In some embodiment, electronic device 200 includes an accelerometer 202 and magnetometer 204. Accelerometer 202 can measure the static and/or dynamic forces of acceleration on an object. For example, accelerometer 202 can be used to determine a vector that is the sum of gravity and linear acceleration experienced by electronic device 200. Magnetometer 204 can measure magnitudes and directions of magnetic fields. For example, magnetometer 204 can be used to determine a vector that points towards the Earth's magnetic north. Magnetometer 204 can also be used to observe different types of magnetic anomalies. Examples of magnetic anomalies include magnetic fields generated by hard-iron interferences that may be temporarily or permanently in a vicinity of electronic device 200. Other examples of magnetic anomalies include, but are not limited to, soft iron anomalies where the materials and geometry of device under test and the surrounding environment modify magnetic flux from the earth field, resulting in passive changes to the observed magnetic field.

Although accelerometer 202 and magnetometer 204 are shown within electronic device 200 in FIG. 2, accelerometer 202 and magnetometer 204 may be positioned outside of electronic device 200 in some embodiments. For example, in such embodiments, accelerometer 202 and magnetometer 204 may be positioned outside a housing of electronic device 200 and may be coupled to electronic device 200 using a wired or wireless network.

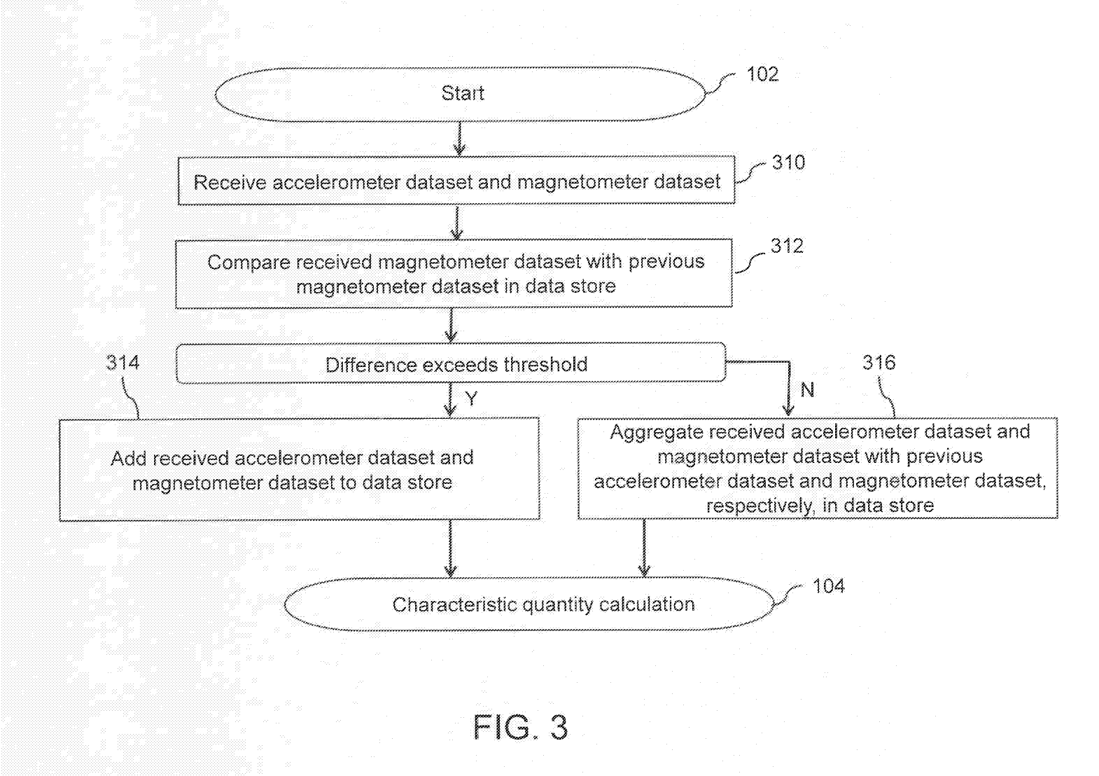

In some embodiments, accelerometer 202 is a three-axis accelerometer. For example, as shown in FIGS. 3A and 3B, accelerometer 202 can have three measurement axes: X_{acc}, Y_{acc}, and Z_{acc}. In some embodiments, accelerometer 202 is a two-axis accelerometer, or accelerometer 202 is configured to determine acceleration along more than three axes. In some embodiments, magnetometer 202 is a three-axis magnetometer. For example, as shown in FIGS. 3A and 3B, magnetometer 204 can have three measurement axes: X_{mag}, Y_{mag}, and Z_{mag}. In some embodiments, magnetometer 204 is a two-axis magnetometer, or magnetometer 204 can be configured to measure magnetic fields along more than three axes. In some embodiments, accelerometer 202 and magnetometer 204 can be micro-electromechanical system (MEMS) devices. In some embodiments, accelerometer 202 and magnetometer 204 can be non-MEMS devices. In some embodiments, accelerometer 202 and magnetometer 204 can fixed relative to each other and/or relative to a housing of electronic device 200. For example, accelerometer 202 and magnetometer 204 can be disposed inside the housing of electronic device 200, or on the housing of electronic device 200. In some embodiments, accelerometer 202 and magnetometer 204 are placed within a single package that is placed on the PCB of electronic device 200. In some embodiments, accelerometer 202 and magnetometer 204 are placed in separate packages that are individually placed on the PCB of electronic device 200.

In some embodiments, electronic device 200 can also include a processor 206 and a memory 208. Memory 208 can include instructions to be executed on processor 206 to determine an estimated acceleration (and in turn an estimated gravity vector) of electronic device 200 and an estimated heading.

Electronic device 200 can include other features and hardware not shown in FIG. 2. For example, electronic device 200 can include the features and hardware described with reference to FIGS. 5 and 6. And in some embodiments, electronic device 200 can include a gyroscope, an altimeter, and/or a temperature sensor.

Method 100 includes data collection step 102. In some embodiments, at step 102, a plurality of accelerometer datasets and a plurality of respective magnetometer datasets are collected from accelerometer 202 and magnetometer 204, respectively, at a plurality of times. In some embodiments, step 102 begins when electronic device 200 is turned on. In some embodiments, each accelerometer dataset includes an x-axis acceleration component (X_{acc}), a y-axis acceleration component (Y_{acc}), and a z-axis acceleration component (Z_{acc}). In some embodiments, each magnetometer dataset includes an x-axis magnetic field component (X_{mag}), a y-axis magnetic field component (Y_{mag}), and a z-axis magnetic field component (Z_{mag}).

In some embodiments, the collected accelerometer and magnetometer datasets are stored in a data store (for example, data store 518 in FIG. 5). For example, the data store can be located in a memory (for example, memory 208 in FIG. 2 or memory 508 in FIG. 5) of the electronic device (for example, electronic device 200 in FIG. 2 or electronic device 500 in FIG. 5).

FIG. 3 is a block diagram of a method for collecting accelerometer and magnetometer data at step 102, according to an embodiment. At step 310, a respective pair of an accelerometer dataset and a magnetometer dataset is collected. At step 312, the received magnetometer dataset is compared with a most recent magnetometer dataset stored in the data store to determine whether the orientation of the electronic device has changed a sufficient amount to warrant adding the respective pair of accelerometer and magnetometer datasets to the data store as a new discrete measurement dataset including the accelerometer and magnetometer dataset. If the change in the orientation of the electronic device exceeds a defined threshold, the received accelerometer and magnetometer datasets are added to the data store as a discrete new measurement. If the change in the orientation of the electronic device does not exceed the defined threshold, the received accelerometer and magnetometer datasets are aggregated with the most recent measurement stored in the data store. For example, at step 312, the angle between an estimated magnetic field vector determined from the magnetometer dataset received is compared to an estimated magnetic field vector determined from the magnetometer dataset of the most recent measurement dataset stored in the data store. In some embodiments, the defined threshold of the angle can range from about 2 degrees to about 8 degrees. In some embodiments, the defined threshold can be about 5 degrees.

In some embodiments, if the angle between the estimated magnetic field vector determined from the magnetometer dataset received and the estimated magnetic field vector determined from the magnetometer dataset of the most recent measurement dataset stored in the data store is greater than the defined threshold, the received magnetometer and accelerometer datasets are added to the data store as a new discrete measurement dataset, and a field for the number of points in the data store contributing to the new measurement is set to 1 at step 314. In some embodiments, if the angle difference between these two estimated magnetic field vectors does not exceed the defined threshold, the received accelerometer and magnetometer datasets are aggregated with the most recent measurement dataset stored in the data store at step 316. For example, at step 316, the received accelerometer and magnetometer datasets can be linearly combined per component value with the respective components of the measurement dataset last stored in the data store, and a weight of N1/(N1+1) is assigned to the prior measurement value and a weight of 1/(N+1) is assigned to the new measurement value. In some embodiments, the weighting can be set to a maximum to limit the amount of time that measurements contribute to the total solution. For example, the maximum can be set to a value of 31 to limit the amount of time that measurements contribute to the total solution.

In some embodiments, data collection step 102 can include a data compression step. For example, after the received accelerometer and magnetometer datasets are stored in the data store (either as a new measurement dataset (step 314) or aggregated with an existing measurement dataset (step 316)), a check is made as to whether to compress the data store. Such data compression can limit the total size of the stored data used for misalignment angle compensation method 100. In some embodiments, the data store contains between about 50 and about 400 measurement datasets. In some embodiments, the data store contains between about 200 and about 400 measurement datasets. In some embodiments, the data store contains less than about 50 measurement datasets or more than about 400 measurement datasets. In some embodiments, a high water mark of measurement datasets can be defined, for example, about 85 to 95 percent of the maximum number of measurement datasets stored in the data store, and a low water mark of measurement datasets can be defined, for example, 65 to 75 percent of the maximum number of measurement datasets stored in the data store. When the number of datasets exceeds the high water mark, data compression can performed to reduce the number of measurement datasets stored in the data store to a number below the low water mark.

In some embodiments, the data compression step reduces the datasets in the data store by using a method similar to the above-described data point aggregation step 316 for new datasets that do not exceed, for example, an angle threshold difference when compared with the most recent dataset stored in the data store. For example, during the data compression step, instead of investigating the angle between the estimated magnetic field vector determined from the magnetometer dataset received and the estimated magnetic field vector determined from the magnetometer dataset of the most recent measurement dataset stored in the data store, angle differences between the estimated magnetic field vectors determined from each magnetometer dataset stored in the data store are calculated. Over the full data store, the pair of datasets with the least difference in angle for estimated magnetic field vectors is combined, for example, linearly combined, into a single dataset, which frees up one dataset location. In some embodiments, combining the pair of datasets in the data store having the least difference in angle for estimated magnetic field vectors continues until the number of datasets in the data store is reduced to the low water mark.

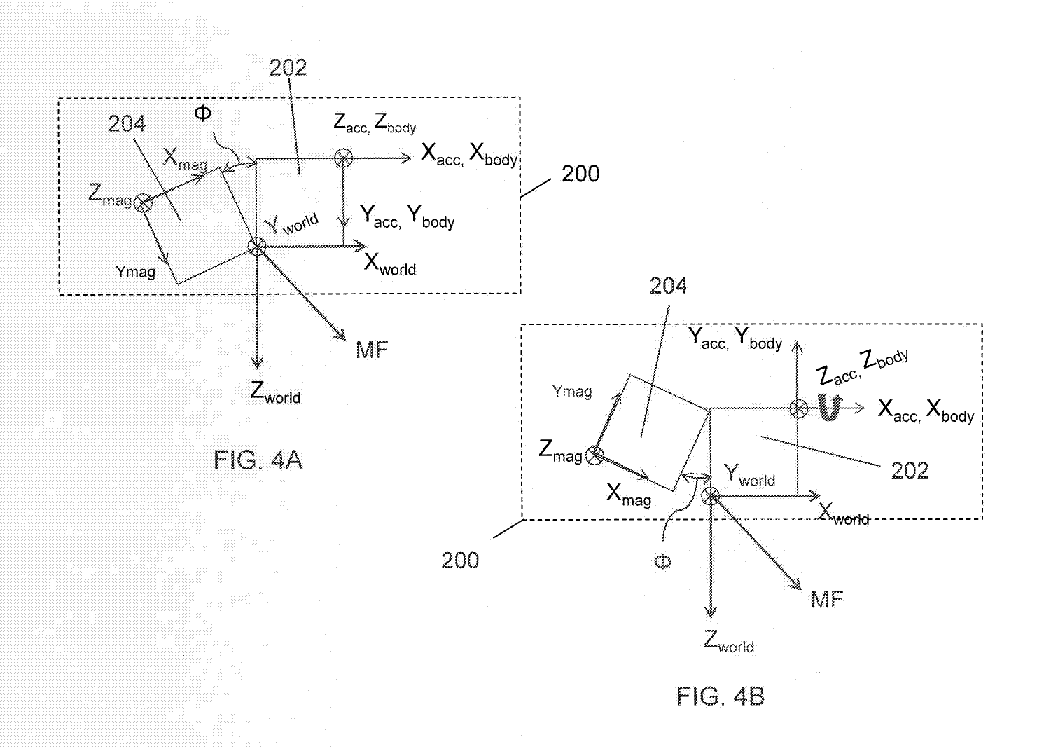

Misalignment angle compensation method 100 also includes step 103 of applying a corrective rotation to collected accelerometer and magnetometer data collected at step 102. Embodiments of step 103 will be explained with reference to FIGS. 4A and 4B, which are schematic diagrams of electronic device 200 having accelerometer 202 and magnetometer 204. In FIGS. 4A and 4B, accelerometer 202 and magnetometer 204 are misaligned. That is, there is an error in the relative orientation between at least one axis of accelerometer 202 (for example, x-axis X_{acc}, y-axis Y_{acc}, and z-axis Z_{acc}) and the respective axis (es) of magnetometer 204 (for example, x-axis X_{mag}, y-axis Y_{mag}, and z-axis Z_{mag}). For example, as shown in FIGS. 4A and 4B, the x-axis X_{acc} and y-axis Y_{acc} of accelerometer 202 can be rotated about a common axis of both accelerometer 202 and magnetometer 204 (for example, a z-axis Z_{body} of electronic device 200, electronic device 200 having an x-axis X_{body}, a y-axis Y_{body}, and z-axis Z_{body}) by a misalignment angle Φ. In some embodiments, misalignment angle Φ has a geometric component (for example, die or package placement), an environmental component (for example, soft iron distortions), or both. Electronic device 200, using accelerometer 202, can calculate an estimated gravity vector, which estimates the world z-axis Z_{world} (the direction of gravity). Although FIG. 4 only shows a z-axis misalignment error component of misalignment angle Φ between accelerometer 202 and magnetometer 204 (misalignment error about z-axis Z_{device}), in some embodiments, misalignment angle Φ can include one or more of an x-axis component, a y-axis component, and a z-axis component.

Electronic device 200, using magnetometer 204, can calculate an estimated magnetic field vector, which estimates the Earth's magnetic field MF. As electronic device 200 moves with a non-zero rotation component that is orthogonal to the direction of gravity (world z-axis Z_{world}), a calculated angle between the estimated gravity vector and the estimated magnetic field vector varies due to misalignment angle Φ. That is, the calculated angle between the estimated gravity vector and the estimated magnetic field vector is asymmetric when the accelerometer and magnetometer data is not compensated for misalignment angle Φ. For example, as shown in FIG. 4B, electronic device 200 is rotated 180 degrees about the x-axis X_{body} of electronic device 200 relative to its position in FIG. 4A. In FIGS. 4A and 4B, the angle between the estimated gravity vector and the estimated magnetic field vector can be calculated at each position. In FIG. 4A, the calculated angle between the estimated gravity vector and the estimated magnetic field vector is equal to the actual angle between the world z-axis Z_{world} and the magnetic field MF plus misalignment angle Φ. And in FIG. 4B, the calculated angle between the estimated gravity vector and the estimated magnetic field vector is equal to the angle between the world z-axis Z_{world} and the magnetic field MF minus misalignment angle Φ. Accordingly, at step 103, a compensation algorithm can be applied to the accelerometer and magnetometer data to compensate for the effect of misalignment angle Φ on the calculated angle between the estimated gravity vector and the estimated magnetic field vector. In some embodiments, the compensation algorithm applies a corrective rotation to at least one of the collected accelerometer data and the magnetometer data. That is, in some embodiments, the compensation algorithm applies a corrective rotation to the collected accelerometer data, the collected magnetometer data, or both the collected accelerometer data and the magnetometer data. In some embodiments, the corrective rotation includes one or more components that correspond to the one or more components of misalignment angle Φ, for example, a corrective x-axis component, a corrective z-axis component, and a corrective y-axis component, and the respective corrective rotation components are applied to the respective components of the collected accelerometer data, the respective components of the collected magnetometer data, or the respective components of both the accelerometer data and the magnetometer data. The magnitude and direction of the corrective rotation (including corrective rotation components) can be based on an estimate of misalignment angle Φ. In some embodiments, any compensation algorithm that is a function of the estimated misalignment angle and that reduces the effects of misalignment angle Φ on the calculated angle between the estimated gravity vector and the estimated magnetic field vector can be used.

Misalignment angle compensation method 100 also includes characteristic calculation step 104. Typically, a misalignment angle between an accelerometer and a magnetometer would be compensated for its effect on a heading determination at the manufacturing stage of the sensor package or PCB including an accelerometer and a magnetometer, and/or at the manufacturing stage of the electronic device that includes an accelerometer and a magnetometer. In some embodiments, instead of compensating for misalignment angle Φ during the manufacturing stage (of the package, PCB, or electronic device 200) to reduce or eliminate its effect on a heading determination, electronic device 200 can compensate a heading determination for misalignment angle Φ during the ordinary operation of electronic device 200. For example, electronic device 200 can compensate for misalignment angle Φ while an end-user (for example, the consumer) ordinarily uses device 200 after the manufacturing stage. During ordinary operation, the end-user moves electronic device 200 and, thus, changes the orientation of electronic device 200 relative to the real world coordinates. During such movement, electronic device 200 collects accelerometer data from accelerometer 202 and magnetometer data from magnetometer 204 (step 102). Electronic device 200 can use this collected data to compensate for misalignment angle Φ and, thus, reduce (or eliminate) its effect on a heading determination using steps 104-108 of method 100, according to an embodiment.

For example, at step 104, a characteristic is calculated for each measurement dataset stored in the data store (for example, data store 518 in FIG. 5). In some embodiments, the acceleration and magnetometer data in the measurement dataset has been compensated according to step 103. In some embodiments, the characteristic is a function of the calculated angle between an estimated gravity vector that approximates Z_{world} in FIGS. 4A and 4B, and an estimated magnetic field vector that estimates the Earth's magnetic field MF in FIGS. 4A and 4B. The estimated gravity vector is calculated from the acceleration data of the measurement dataset stored in the data store, and the estimate magnetic field vector is calculated from the respective magnetometer data in the measurement dataset stored in the data store. In some embodiments, the estimated gravity vector is calculated from acceleration data that has been corrected by applying the corrective rotation. In some embodiments, the estimated magnetic field vector is calculated from the magnetometer data that has been corrected by applying the corrective rotation. In some embodiments, the characteristic is the calculated angle between the estimated gravity vector and the estimated magnetic field vector MF, itself. In some embodiments, the characteristic is the dip angle of the magnetic field (angle between the horizon and the magnetic field vector). The magnetic dip angle is complementary to the calculated angle between the estimated gravity vector and the estimated magnetic field vector. In some embodiments, the characteristic is a normalized cross-product of the estimated gravity vector and the estimated magnetic field vector (for example, |Z_{world}|×|MF|/(|Z_{world}∥MF|)), or any other characteristic that is a monotonic function of the angle between the estimated gravity vector and the estimated magnetic field vector.

In some embodiments, referring to FIGS. 4A and 4B, the characteristic is asymmetric as electronic device 200 moves with a non-zero rotation component that is orthogonal to the direction of gravity (the world z-axis Z_{world})—the rotational axis is not parallel to the world z-axis. Asymmetry in the characteristic as the electronic device moves with a non-zero rotation component that is orthogonal to the direction of gravity can indicate that the accelerometer and magnetometer data has not been substantially compensated for misalignment angle Φ. In some embodiments, when the change of the characteristic is minimized as the electronic device moves with a non-zero rotation component that is orthogonal to the direction of gravity, the accelerometer and magnetometer data is substantially compensated for misalignment angle Φ. In some embodiments, the misalignment angle Φ is the only source of asymmetry, and accordingly, the asymmetry of the characteristic would be completely removed through the compensation process. However, in some embodiments, there are additional sources of asymmetry. For example, a bias sensor error between the estimated gravity vector and the true world z-axis. When multiple sources of asymmetry exist, compensating for misalignment angle Φ will reduce the change of the characteristic as the electronic device moves with a non-zero rotation component that is orthogonal to the direction of gravity and, thus, reduce the asymmetry, but the asymmetry may not be completely eliminated.

Compensation method 100 also includes a figure of merit calculation step 106. For example, at step 106, a figure of merit that quantifies the asymmetry of the characteristic is calculated across the range of solid angles represented by the measurement datasets in the data store, in some embodiments. In some embodiments, the figure of merit converges at a minimum value when the characteristic is substantially symmetric as the electronic device moves with a non-zero rotation component that is orthogonal to the direction of gravity, which indicates the accelerometer and magnetometer data has been substantially compensated for misalignment angle Φ.

In some embodiments, the figure of merit is a function of a difference between the characteristic for each measurement dataset stored in the date store and the mean of the characteristic over the measurement datasets stored in the data store. One example of such a figure of merit is a moment about the mean of the characteristic over the measurement datasets. For example, the figure of merit can be a second moment about the mean of the characteristic, that is, a variance of the characteristics. When the variance of the characteristics converges toward a minimum value, the acceleration and magnetometer data is substantially compensated for misalignment angle Φ. In some embodiments in which substantially no noise or sources of asymmetry exist (for example, sensor bias error), the variance would converge to zero. Additional examples of a figure of merit are third, fourth, or more than fourth moments about the mean of the characteristic. Another example of a figure of merit that is a function of a difference between the characteristic for each measurement dataset and the mean of the characteristics includes a standard deviation of the characteristic over the measurement datasets, that is, a square root of the second moment of the mean of the characteristic.

A further example of such a figure of merit that is a function of a difference between the characteristic for each measurement dataset stored in the date store and the mean of each characteristic for each measurement dataset includes a figure of merit that is a function of an expected value of an absolute value of a difference between a characteristic at each of the measurement datasets and a mean of the characteristic over the plurality of measurement datasets. For example, the figure of merit can be characterized as E=[|X−E[X]|^{k}], where X is the characteristic, and k is the order. In some embodiments, k is equal to 1, 2, 3, or more than 3.

In some embodiments, a characteristic that is a function of the angle between an estimated gravity vector and an estimated magnetic field vector will be asymmetric as the electronic device moves with a non-zero rotation component that is orthogonal to the direction of gravity when a compensation algorithm has not fully compensated the acceleration and magnetometer data for misalignment angle Φ. For example, referring to FIGS. 4A and 4B, an estimated gravity vector (which estimates the world z-axis Z_{world}) and an estimated magnetic field vector (which estimates the Earth's magnetic field MF) can be determined from corrected accelerometer and magnetometer data of a measurement dataset stored in the data store. The calculated angle between the estimated gravity vector and the estimated magnetic field vector can be calculated. Referring to FIGS. 4A and 4B, misalignment angle Φ (which can include one or more components, for example, an x-axis component, a y-axis component, and a z-axis component) exists between accelerometer 202 and magnetometer 204. As shown in FIG. 4B, electronic device 200 is rotated 180 degrees about the x-axis X_{body} of electronic device 200 relative to its position in FIG. 4A. In FIGS. 4A and 4B, the angle between the estimated gravity vector and the estimated magnetic field vector can be calculated at each position. In FIG. 4A, the estimated angle between the estimated gravity vector and the estimated magnetic field vector is equal to the angle between the world z-axis Z_{world} and the magnetic field MF plus misalignment angle Φ. And in FIG. 4B, the estimated angle between the estimated gravity vector and the estimated magnetic field vector is equal to the angle between the world z-axis Z_{world} and the magnetic field MF minus misalignment angle Φ. In some embodiments, these two points represent the end points of the range within which the characteristic changes. This asymmetry of the calculated angle between the estimated gravity vector and the estimated magnetic field vector and, consequently, of the characteristic (for example, the calculated angle between the estimated gravity vector and the estimated magnetic field vector of MF, itself; the magnetic dip angle; the cross product of the estimated gravity vector and the estimated magnetic field vector, etc.) indicates that accelerometer and magnetometer data has not yet been substantially compensated for misalignment angle Φ. When misalignment angle Φ is not compensated for fully, the calculated angle between the estimated gravity vector and the estimated magnetic field vector continuously vary as electronic device 200 moves with a non-zero rotation component that is orthogonal to the direction of gravity. When misalignment angle Φ is not substantially compensated for, the figure of merit does not converge at a value. Accordingly, method 100 proceeds to an estimated misalignment angle adjustment step 108.

In some embodiments, at step 108, an estimated misalignment angle used in misalignment compensation algorithm (step 103) can be adjusted to reduce or eliminate the effect of misalignment angle Φ on the calculated angle between the estimated gravity vector and the estimated magnetic field vector. In some embodiments, at step 108, the estimated misalignment angle (which can include one or more components, for example, an x-axis component, a y-axis component, and a z-axis component) is adjusted such that the figure of merit (for example, a variance) converges to a minimum value. In this manner, such convergence indicates that the estimated misalignment angle is substantially equal to the actual misalignment angle. Accordingly, any accelerometer and magnetometer data compensated based on such an estimated misalignment angle has been substantially compensated for the actual misalignment angle Φ. For example, if the figure of merit is a variance of the calculated angle between the estimated gravity vector and the estimated magnetic field vector, the figure of merit converges to a minimum value when the accelerometer and magnetometer data has been substantially compensated for misalignment angle Φ. For example, after one or more iterations of adjusting the estimated misalignment angle Φ (step 108) and compensating the acceleration and magnetometer data based on the estimated misalignment angle Φ (step 103), the calculated angle between the estimated gravity vector and the estimated magnetic field vector becomes smaller. Thus, the figure of merit (for example, a variance of the angle between the estimated gravity vector and the estimated magnetic field vector) of electronic device 200 in FIGS. 4A and 4B is smaller—the figure of merit is converging. This decrease in the figure of merit indicates that the estimated misalignment angle is become closer to the actual misalignment angle Φ, but until the figure of merit converges to a minimum value, the estimated misalignment angle is not substantially equal to actual misalignment angle Φ. The estimated misalignment angle of a compensation algorithm is iteratively adjusted until the figure of merit (for example, variance of the characteristic) converges to a value within a predetermined threshold. In some embodiments, the estimated misalignment angle is also dynamically adjusted during the ordinary operation of electronic device 200. That is, the estimated misalignment angle is adjusted after the manufacturing stage of the accelerometer, magnetometer, and/or electronic device. In some embodiments, dynamically compensating for misalignment angle Φ allows the effects of changes in the environment on misalignment angle Φ to be compensated for. For example, dynamically changing the estimated misalignment angle Φ allows for compensation of temperature shifts, package stress changes, and other environmental changes that affect the misalignment angle Φ after the manufacturing stage.

In some embodiments, dynamically adjusting the estimated misalignment angle of the compensation algorithm during ordinary operation of electronic device 200 reduces or eliminates the need to obtain a truth reference or manually compensate for misalignment angle Φ. In such embodiments, compensating for misalignment angle Φ during the manufacturing stage of the accelerometer, magnetometer, and/or electronic device can be omitted. This omission can reduce production time of the accelerometer, magnetometer, and/or electronic device and, thus, reduce manufacturing costs.

In some embodiments, dynamically compensating for misalignment angle Φ during ordinary operation of the electronic device allows compensation for changes that affect misalignment angle Φ that occur after manufacturing. Such changes include, for example, temperature shifts, changing mechanical stresses on the package of the accelerometer in the electronic device, and/or soft iron distortions that can twist the magnetic field. Accordingly, in some embodiments, the electronic device can accurately determine a heading, for example, for use with a navigation application. In some embodiments, dynamically compensating for misalignment angle Φ during ordinary operation of the electronic device occurs without any explicit action by device manufacturer or the end-user.

In some embodiments, the estimated misalignment angle used in a compensation algorithm is adjusted by using a gradient path to converge the figure of merit. In some embodiments using a gradient path, the estimated misalignment angle is varied successively for each iteration of the estimated misalignment angle calculation. For each update, three misalignment angle estimates are used: prompt, early, and late misalignment angle estimates. The most recent estimate is the prompt estimate. The early estimate is the prompt estimate minus the angle span, and the last estimate is the prompt estimate plus the angle span. If the figure of merit is monotonic for the prompt, early, and late misalignment angle estimates, the misalignment angle estimates are shifted by the angle span in the direction of the lower valued figure of merit and recalculated. In some embodiments, the calculated misalignment angle estimates are re-used so that one new value is calculated for the figure of merit for each shift. Once the misalignment angle estimates are calculated such that the figure of merit is no longer monotonic from early to late estimates, peak refinement can occur. Using a peak refinement algorithm in some embodiments, the estimated misalignment angles corresponding to the two lowest values for the figure of merit are refined to five points. The two original points in the refinement are the second and fourth points of the five-point refinement cycle. The first point is the sum of minus one half of the angle span and the second point. The third point is the sum of one half of the angle span and the refined second point. And the fifth point is the sum of one half of the angle span and the refined fourth point. The angle span is then updated for the next cycle. In some embodiments, the angle span is updated by reducing in half. In some embodiments, this cycle continues as long as clear minima are observed in the refined five point series and until a minimum separation threshold is crossed. In some embodiments, the final refinement quadratically interpolates the three lowest points of the last five point refinement cycle.

In some embodiments, the adjustment of the estimated misalignment angle ceases after the figure of merit converges. In some embodiments, the adjustment of the estimated misalignment angle continues after the figure of merit converges.

In some embodiments, magnetometer 204 can be calibrated before compensating for misalignment angle Φ according to the above described embodiments. In some embodiments, accelerometer 202 can be calibrated before compensating for misalignment angle Φ according to the above described embodiments. In some embodiments in which magnetometer 204 and accelerometer 202 are calibrated first, the figure of merit converges more quickly and accurately relative to not first calibrating accelerometer 202 and/or magnetometer 204. Calibrating the accelerometer 202 and/or magnetometer 204 first can maximize the observable figure of merit, reducing the effect of sensor noise.

In some embodiments, method 100 further includes a step of determining whether the estimated misalignment angle is substantially equal to the actual misalignment angle Φ. For example, the estimated misalignment angle can be determined to equal the actual misalignment angle when the figure of merit converges at a minimum value.

FIG. 5 is a block diagram of an electronic device 500 according to an embodiment. Electronic device 500 can include an accelerometer 502, a magnetometer 504, a processor 506, and a memory 508. Memory 508 may include instructions 520 configured to be executed or interpreted by processor 506. Instructions 520 can include code that cause processor 506 to perform one or more steps of compensation method 100 as discussed above. Memory 508 can also include a data store 518 that includes measurement datasets (including, in some embodiments, received accelerometer and magnetometer data) used in compensation method 100. Memory 508 can also include a registry 522 of an estimated misalignment angle used in a compensation algorithm to minimize or reduce an effect of misalignment on a heading determination.

Various embodiments can be implemented, for example, using one or more well-known computer systems, such as computer system 636 shown in FIG. 6. Computer system 636 can be any well-known computer capable of performing the functions described herein, such as computers available from International Business Machines, Apple, Sun, HP, Dell, Sony, and Toshiba, to name a few examples.

Computer system 636 includes one or more processors (also called central processing units, or CPUs), such as a processor 638. Processor 638 is connected to a communication infrastructure or bus 640. In an embodiment, processor 638 may be a graphics processing unit (GPU). A GPU is a processor that is a specialized electronic circuit designed to rapidly process mathematically intensive applications on electronic devices. The GPU has a highly parallel structure that is efficient for parallel processing of large blocks of data, such as mathematically intensive data common to computer graphics applications, images and videos.

Computer system 636 also includes user input/output device(s) 642, such as monitors, keyboards, pointing devices, etc., which communicate with communication infrastructure 640 through user input/output interface(s) 644.

Computer system 626 also includes a main or primary memory 646, such as random access memory (RAM). Main memory 646 may include one or more levels of cache. Main memory 646 has stored therein control logic (i.e., computer software) and/or data.

Computer system 636 may also include one or more secondary storage devices or secondary memory 648. Secondary memory 648 may include, for example, a hard disk drive 650 and/or a removable storage device or drive 652. Removable storage drive 652 may be a floppy disk drive, a magnetic tape drive, a compact disk drive, an optical storage device, tape backup device, and/or any other storage device/drive.

Removable storage drive 652 may interact with a removable storage unit 654. Removable storage unit 654 includes a computer usable or readable storage device having stored thereon computer software (control logic) and/or data. Removable storage unit 654 may be a floppy disk, magnetic tape, compact disk, DVD, optical storage disk, or any other computer data storage device. Removable storage drive 652 reads from and/or writes to removable storage unit 654 in a well-known manner.

According to an exemplary embodiment, secondary memory 648 may include other means, instrumentalities or approaches for allowing computer programs and/or other instructions and/or data to be accessed by computer system 636. Such means, instrumentalities or approaches may include, for example, a removable storage unit 656 and an interface 658658. Examples of the removable storage unit 656 and the interface 658658 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 636 may further include a communication or network interface 660. Communication interface 660 enables computer system 636 to communicate and interact with any combination of remote devices, remote networks, remote entities, etc. (individually and collectively referenced by reference number 662). For example, communication interface 660 may allow computer system 636 to communicate with remote devices 662 over communications path 664, which may be wired, and/or wireless, and which may include any combination of LANs, WANs, the Internet, etc. Control logic and/or data may be transmitted to and from computer system 636 via communication path 664.

In an embodiment, a tangible apparatus or article of manufacture comprising a tangible computer useable or readable medium having control logic (software) stored thereon is also referred to herein as a computer program product or program storage device. This includes, but is not limited to, computer system 636, main memory 646, secondary memory 648, and removable storage units 654 and 656, as well as tangible articles of manufacture embodying any combination of the foregoing. Such control logic, when executed by one or more data processing devices (such as computer system 636), causes such data processing devices to operate as described herein.

Based on the teachings contained in this disclosure, it will be apparent to persons skilled in the relevant art(s) how to make and use the embodiments using data processing devices, computer systems and/or computer architectures other than that shown in FIG. 6. In particular, embodiments may operate with software, hardware, and/or operating system implementations other than those described herein.

It is to be appreciated that the Detailed Description section, and not the Summary and Abstract sections (if any), is intended to be used to interpret the claims. The Summary and Abstract sections (if any) may set forth one or more but not all exemplary embodiments as contemplated by the inventor(s), and thus, are not intended to limit the embodiments or the appended claims in any way.

While the embodiments have been described herein with reference to exemplary embodiments for exemplary fields and applications, it should be understood that the subject matter is not limited thereto. Other embodiments and modifications thereto are possible, and are within the scope and spirit of the subject matter. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” “some embodiments,” “examples,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the embodiments should not be limited by any of the above-described exemplary embodiments, but should be defined only in accordance with the following claims and their equivalents.

What is claimed is:

1. A method for compensating for a misalignment angle between an accelerometer and a magnetometer, comprising:
receiving accelerometer data from an accelerometer at a plurality of times;
receiving magnetometer data from a magnetometer at a plurality of times;
applying a corrective rotation to at least one of the accelerometer data and the magnetometer data based on an estimated misalignment angle at the plurality of times, the estimated misalignment angle being an estimate of an actual misalignment angle between an axis of the accelerometer and an axis of the magnetometer;
estimating a gravity vector using the accelerometer data at the plurality of times;
estimating a magnetic field vector using the magnetometer data at the plurality of times;
calculating a characteristic that is a function of a calculated angle between the estimated gravity vector and the estimated magnetic field at each of the plurality of times;
calculating a figure of merit over the plurality of times that is a function of the characteristic; and
dynamically adjusting the estimated misalignment angle during use of the electronic device such that the figure of merit converges to a value as the electronic device moves with a non-zero rotation component that is orthogonal to a direction of gravity,
wherein convergence of the figure of merit to the value indicates the estimated misalignment alignment angle is substantially equal to the actual misalignment error.

2. The method of claim 1, wherein the characteristic is a magnetic dip angle.

3. The method of claim 1, wherein the characteristic is a normalized cross-product of the estimated gravity vector and the estimated magnetic field vector.

4. The method of claim 1, wherein the characteristic is the angle between the estimated gravity vector and the estimated magnetic field.

5. The method of claim 1, wherein the figure of merit is a moment about a mean of the characteristic over the plurality of times.

6. The method of claim 5, wherein the moment is a second moment about the mean of the characteristic over the plurality of times.

7. The method of claim 5, wherein the moment is a third or higher moment about a mean of the characteristic over the plurality of times.

8. The method of claim 1, wherein the figure of merit is a square root of a second moment about a mean of the characteristic over the plurality of times.

9. The method of claim 1, wherein the figure of merit is a function of an expected value of an absolute value of a difference between a characteristic at each of the plurality of times and a mean of the characteristic over the plurality of times.

10. The method of claim 1, wherein adjusting the estimated misalignment angle comprises using a gradient path.

11. The method of claim 1, further comprising calibrating the magnetometer before dynamically adjusting the estimated misalignment angle.

12. The method of claim 1, further comprising calibrating the accelerometer before dynamically adjusting the estimated misalignment angle.
The method of claim 1, further comprising: adding the received accelerometer data and the received magnetometer data at the plurality of times to a data store when a difference between the received magnetometer data and magnetometer data last stored in a data store is greater than a defined threshold;
aggregating the received accelerometer data and the magnetometer data with accelerometer data and the magnetometer data last stored in the data store when the difference between the received magnetometer dataset and the magnetometer dataset last stored in the data store is less than a defined threshold.

13. The method of claim 12, wherein the threshold is approximately a 5 degree angle between a magnetic field vector derived from the respective received magnetometer dataset and the magnetic field vector derived from the magnetometer dataset last stored in the data store.

14. The method of claim 1, wherein the plurality of times at which the accelerometer data is received is the same as the plurality of times at which the magnetometer data is received.

15. A system comprising:
an accelerometer;
a magnetometer;
a processor; and
a memory storing an estimated misalignment angle between an axis of the accelerometer and an axis of the magnetometer and instructions to be executed by the processor, the instructions comprising:
applying a corrective rotation to at least one of accelerometer data and magnetometer data based on an estimated misalignment angle at a plurality of times, the estimated misalignment angle being an estimate of an actual misalignment angle between an axis of the accelerometer and an axis of the magnetometer, the accelerometer data being received from the accelerometer, the magnetometer data being received from the magnetometer;
estimating a gravity vector using the accelerometer data at the plurality of times;
estimating a magnetic field vector using the magnetometer data at the plurality of times;
calculating a characteristic that is a function of a calculated angle between the estimated gravity vector and the estimated magnetic field at each of the plurality of times;
calculating a figure of merit over the plurality of times that is a function of the characteristic; and
dynamically adjusting the estimated misalignment angle during ordinary use of the electronic system such that the figure of merit converges to a value as an electronic device moves with a non-zero rotation component that is orthogonal to a direction of gravity,
wherein convergence of the figure of merit to the value indicates the estimated misalignment alignment angle is substantially equal to the actual misalignment error.

16. The system of claim 15, wherein the characteristic is a magnetic dip angle.

17. The system of claim 15, wherein the characteristic is a normalized cross-product of the estimated gravity vector and the estimated magnetic field vector.

18. The system of claim 15, wherein the characteristic is the angle between the estimated gravity vector and the estimated magnetic field.

19. The system of claim 15, wherein the figure of merit is a moment about a mean of the characteristic over the plurality of times.

20. The system of claim 15, wherein the moment is a second moment about the mean of the characteristic over the plurality of times.

21. The system of claim 15, wherein the moment is a third or higher moment about a mean of the characteristic over the plurality of times.

22. The system of claim 15, wherein the figure of merit is a square root of a second moment about a mean of the characteristic over the plurality of times.

23. The system of claim 15, wherein the figure of merit is a function of an expected value of an absolute value of a difference between a characteristic at each of the plurality of times and a mean of the characteristic over the plurality of times.

24. The system of claim 15, wherein adjusting the estimated misalignment angle comprises using a gradient path.

25. The system of claim 15, wherein the instructions further comprise calibrating the magnetometer before dynamically adjusting the calibration parameter.

26. The system of claim 15, wherein the instructions further comprise calibrating the accelerometer before dynamically adjusting the calibration parameter.

27. The system of claim 15, wherein the accelerometer and the magnetometer are contained within a housing of the electronic device.
